(19) United States
(12) Patent Application Publication
(10) Pub. No.: US 2004/0124962 A1
(43) Pub. Date: Jul. 1, 2004

(54) Protection device for a fuse device

(76) Inventor: Ching-Lung Tseng, Hsien (TW)

Correspondence Address: SUPREME PATENT SERVICES, POST OFFICE BOX 2339, SARATOGA, CA, 95070, US

(21) Appl. No.: 10/329,724

(22) Filed: Dec. 26, 2002

(51) Int. Cl. H01H 85/175

(52) U.S. Cl. 337/187; 337/186

(57) ABSTRACT

An electric device includes a casing made of electric non-conductive material and two circuit members are respectively received in the casing. Two terminals are connected to the two circuit members and extending from an underside of the casing. A metal wire is attached to an outer surface of the casing and two ends of the metal wire extend into the casing and are connected to the two circuit members.

### FIELD OF THE INVENTION

The present invention relates to a protection device that is attached on a surface of a plastic casing and has two ends respectively connected with two electric parts in the casing. By the protection device, the electric part in the casing can be protected.

1. Background of the Invention

A conventional electric device 10 is shown in FIG. 1 and generally includes a casing 11 that is made of electric non-conductive material and an electric part 13 is received in the casing 11. Two terminals 15 are welded to the electric part 13. There is no fuse to protect the electric part 13 so that the electric part could be damaged or the casing 11 could be burned if the current is provided abnormally.

The present invention intends to provide a protection that includes a metal wire attached to the casing and connected to the electric part so that the metal wire is used as a fuse and can protect the electric part from being burned or damaged due to the abnormal current.

2. Summary of the Invention

In accordance with one aspect of the present invention, there is provided an electric device having a protection device wherein the electric device comprises a casing and a first circuit member and a second circuit member are respectively received in the casing. Two terminals are connected to the first circuit member and the second circuit member respectively and extend from the casing. The protection device includes a metal wire attached to an outer surface of the casing and two ends of the metal wire extend into the casing and are connected to the first circuit member and the second circuit member respectively.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional electric device;

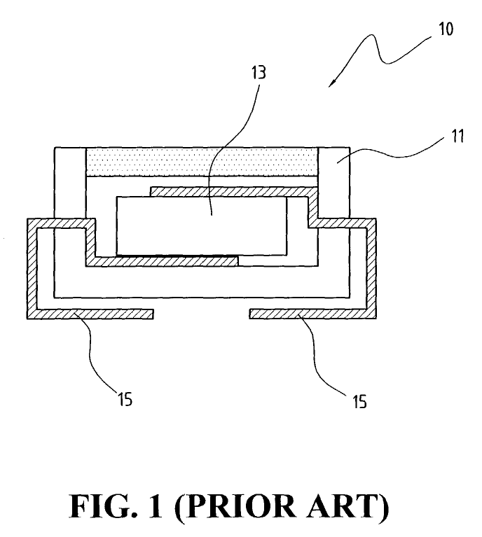

FIG. 2 is a perspective view to show the electric device having the protection device of the present invention;

FIG. 3 is a cross sectional view taken along the line A-A in FIG. 2 to show the electric device having the protection device of the present invention;

FIG. 4 is a perspective view to show another embodiment of the electric device having the protection device of the present invention;

FIG. 5A shows a cross sectional view taken along the line B-B′ in FIG. 4;

FIG. 5B shows a cross sectional view taken along the line C-C′ in FIG. 4; and

FIG. 6 shows yet another embodiment of the electric device having the protection device of the present invention.

### DETAILED DESCRIPTION OF THE PREFERRED EMBODIMENT

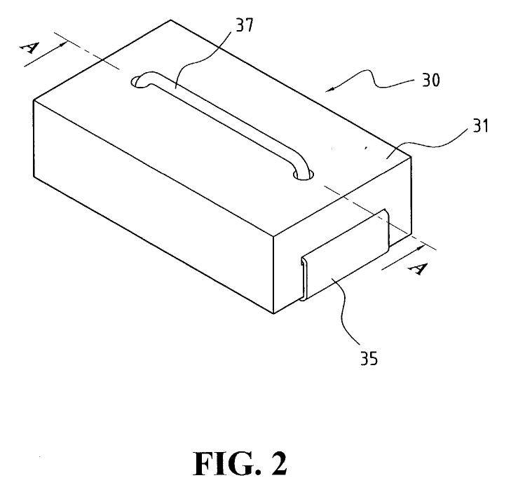

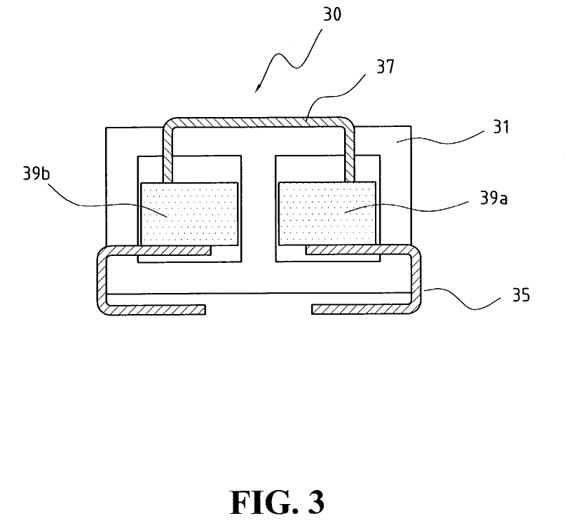

Referring to FIGS. 2 and 3, the electric device 30 having a protection device of the present invention comprises a casing 31 made of electric non-conductive material such as silicon rubber, Teflon, bakelite, resin or plastic. A first circuit member 39a and a second circuit member 39b are respectively received in the casing 31. Two U-shaped terminals 35 are connected to the casing 31 and one end of the terminals 35 is located to an underside of the casing 31 so as to be a welding port and the other end of the terminals 35 is connected to first circuit member 39a and the second circuit member 39b respectively. The terminals 35 can be tinned metal terminals. The first circuit member 39a and the second circuit member 39b can respectively be electricity-sensitive resistance, pressure-sensitive resistance, or capacitor.

A metal wire 37 is attached to an outer surface of the casing 31 and two ends of the metal wire 37 extend into the casing 31 and are connected to the first circuit member 39a and the second circuit member 39b respectively.

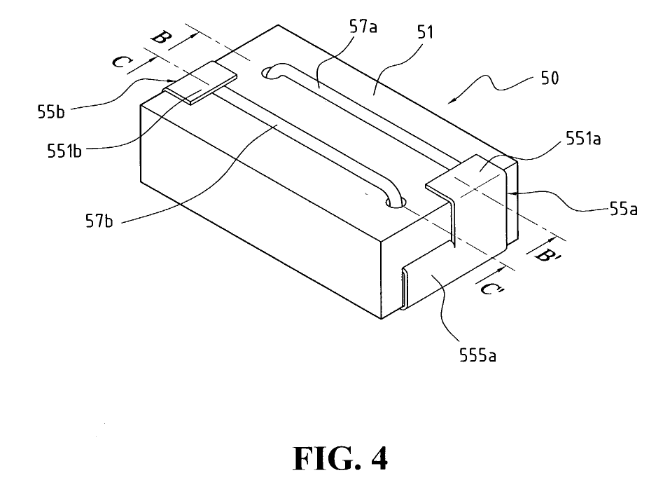

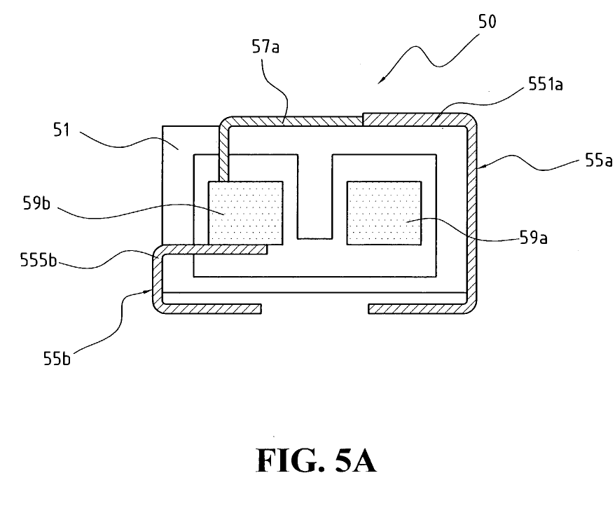

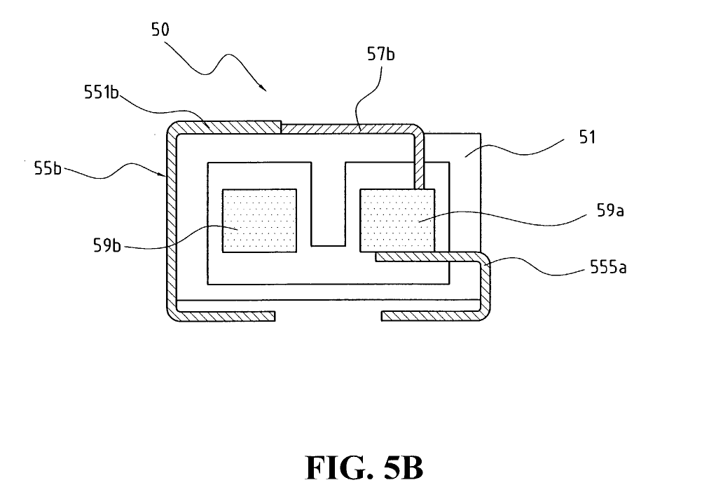

FIGS. 4, 5A and 5B, which show that the electric device 50 includes two circuit members that are connected in parallel with each other. The casing 51 that has a first circuit member 59a and a second circuit member 59b respectively received therein. A first terminal 55a and a second terminal 55b are connected to two ends of the casing 51. A first metal wire 57a is attached to an outer surface of the casing 51 and one end of the first metal wire 57a extends into the casing 51 and is connected to the first circuit member 59a. A second metal wire 57b is attached to the outer surface of the casing 51 and one end of the second metal wire 57b extends into the casing 51 and is connected to the second circuit member 59b. A first end 551a of the first terminal 55a is connected to the first metal wire 57a and a second end 555a of the first terminal 55a is connected to the first circuit member 59a. A first end 551b of the second terminal 55b is connected to the second metal wire 57b and a second end 555b of the second terminal 55b is connected to the second circuit member 59b.

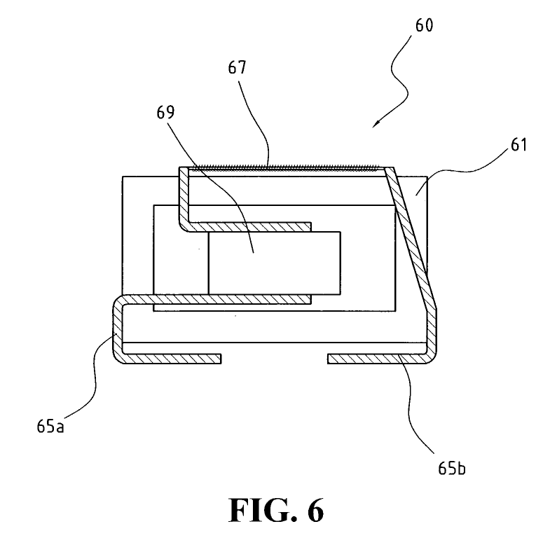

FIG. 6 shows yet another embodiment of the electric device 60 and comprises a casing 61 with a circuit member 69 received therein. A first terminal 65a and a second terminal 65b are respectively connected to two ends of the casing 31. A metal wire 67 is attached to an outer surface of the casing 31 and connected between the circuit member 69 and a first end of the first terminal 65a. A second end of the first terminal 65a is located to an underside of the casing 61. A first end of the second terminal 65b is connected to the circuit member 69 and a second end of the second terminal 65b is located to the underside of the casing 61.

The metal wires function as a fuse so as to protect the circuit members in the casing.

While we have shown and described the embodiment in accordance with the present invention, it should be clear to those skilled in the art that further embodiments may be made without departing from the scope of the present invention.

What is claimed is:

1. An electric device having a protection device, comprising:
a casing;
a first circuit member and a second circuit member respectively received in the casing, two terminals connected to the first circuit member and the second circuit member respectively and extending from the casing; and
a metal wire attached to an outer surface of the casing and two ends of the metal wire extending into the casing and connected to the first circuit member 39a and the second circuit member respectively.

2. An electric device having a protection device, comprising:
a casing;
a first circuit member and a second circuit member respectively received in the casing, a first terminal and a second terminal connected to two ends of the casing, a first metal wire attached to an outer surface of the casing and one end of the first metal wire extending into the casing and connected to the first circuit member, a second metal wire attached to the outer surface of the casing and one end of the second metal wire extending into the casing and connected to the second circuit member, and
a first end of the first terminal connected to the first metal wire and a second end of the first terminal connected to the first circuit member, a first end of the second terminal connected to the second metal wire and a second end of the second terminal connected to the second circuit member.

3. An electric device having a protection device, comprising:
a casing;
a circuit member received in the casing, a first terminal and a second terminal respectively connected to two ends of the casing;
a metal wire attached to an outer surface of the casing and connected between the circuit member and a first end of the first terminal, a second end of the first terminal located to an underside of the casing; and
a first end of the second terminal connected to the circuit member and a second end of the second terminal located to the underside of the casing.
